(19) United States
(12) Patent Application Publication
(10) Pub. No.: US 2013/0148016 A1
(43) Pub. Date: Jun. 13, 2013

(54) CAMERA MODULE

(71) Applicants: Seung Yun Oh, Gyunggi-do (KR); Jae Hoon Lee, Gyunnggi-do (KR); In Taek Song, Gyunggi-do (KR); Tae Young Kim, Seoul (KR)

(72) Inventors: Seung Yun Oh, Gyunggi-do (KR); Jae Hoon Lee, Gyunnggi-do (KR); In Taek Song, Gyunggi-do (KR); Tae Young Kim, Seoul (KR)

(73) Assignee: SAMSUNG ELECTRO-MECHANICS CO., LTD., Gyunggi-do (KR)

(21) Appl. No.: 13/408,995

(22) Filed: Feb. 29, 2012

(30) Foreign Application Priority Data
Dec. 9, 2011 (KR) 1020110131954

(51) Int. Cl. H04N 5/225

(52) U.S. Cl. 348/374; 348/E05.026

(57) ABSTRACT

Disclosed herein is a camera module. The camera module according to preferred embodiments of the present invention includes: a housing; a printed circuit board disposed in the housing and having a heat dissipating hole formed at a first side thereof; an image sensor bonded to the printed circuit board and disposed on one surface of the heat dissipating hole; and a heat dissipating part having one side contacting the image sensor and the printed circuit board through the heat dissipating hole and the other side disposed at the outside of the housing to discharge heat generated from the image sensor and the printed circuit board to the outside of the housing.

### CROSS REFERENCE TO RELATED APPLICATION

This application claims the benefit of Korean Patent Application No. 10-2011-0131954, filed on Dec. 9, 2011, entitled “Camera Module,” which is hereby incorporated by reference in its entirety into this application.

### BACKGROUND OF THE INVENTION

1. Technical Field

The present invention relates to a camera module.

2. Description of the Related Art

Recently, a focus of a car industry has been expanded to include the safety and convenience of a user, on the basis of improved engine performance.

Further, various products using radar and image sensors have been developed due to the increased interest in safety and convenience in order to improve the safety and convenience of a driver.

While car makers are adopting cameras, consumers request that a camera be hidden without altering a design by considering the physical appearance since the camera is mounted in a vehicle. Therefore, the camera for a vehicle needs to be miniaturized.

Since the camera size is miniaturized and has many features, a considerable amount of heat is generated in a camera module. Therefore, camera module industries need to solve a problem of effectively dissipating heat.

In particular, since the existing front camera is disposed in front of an engine room, the camera module is directly applied with heat generated from the engine room and generates heat itself Therefore, when the heat is not effectively dissipated, the deterioration in image quality due to high temperature may occur.

### SUMMARY OF THE INVENTION

The present invention has been made in an effort to provide a camera module capable of discharging heat generated in a housing to the outside.

Further, the present invention has been made in an effort to provide a camera module capable of easily discharging heat generated from an image sensor and a printed circuit board disposed in a housing to the outside.

In addition, the present invention has been made in an effort to provide a camera module capable of mitigating an impact of an image sensor and a heat dissipating part.

According to a preferred embodiment of the present invention, there is provided a camera module, including: a housing; a printed circuit board disposed in the housing and having a heat dissipating hole formed at a first side thereof; an image sensor bonded to the printed circuit board and disposed on one surface of the heat dissipating hole; and a heat dissipating part having one side contacting the image sensor and the printed circuit board through the heat dissipating hole and the other side disposed at the outside of the housing to discharge heat generated from the image sensor and the printed circuit board to the outside of the housing.

The heat dissipating part may further include a buffer member that is disposed at the heat dissipating hole of the printed circuit board and may be disposed between the image sensor and the heat dissipating part to absorb impact between the image sensor and the heat dissipating part.

The buffer member may be formed in a pillar shape having a predetermined thickness and one surface thereof may contact the image sensor and a side thereof may contact an inner side of the heat dissipating hole of the printed circuit board.

The buffer member may be made of heat conductive synthetic resin or grease.

The buffer member may be formed in a liquid-phase or gel form.

The heat conductive synthetic resin may be made of poron.

The grease may be made of thermal grease.

The housing may further include a fixing member that detachably fixes the heat dissipating part.

The fixing member may be formed of a screw.

The other side of the heat dissipating part may be provided with a plurality of heat dissipating plates.

The heat dissipating part may be made of aluminum or copper.

### BRIEF DESCRIPTION OF THE DRAWINGS

FIG. 1 is a cross-sectional view showing a camera module according to a preferred embodiment of the present invention.

FIG. 2 is an exploded perspective view of main components of a camera module according to a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings.

In the specification, in adding reference numerals to components throughout the drawings, it is to be noted that like reference numerals designate like components even though components are shown in different drawings.

Further, the present invention is not limited to the embodiments set forth herein but may be modified in many different forms. When it is determined that the detailed description of the known art related to the present invention may obscure the gist of the present invention, the detailed description will be omitted.

Hereinafter, preferred embodiments of the present invention will be described in detail with reference to the accompanying drawings.

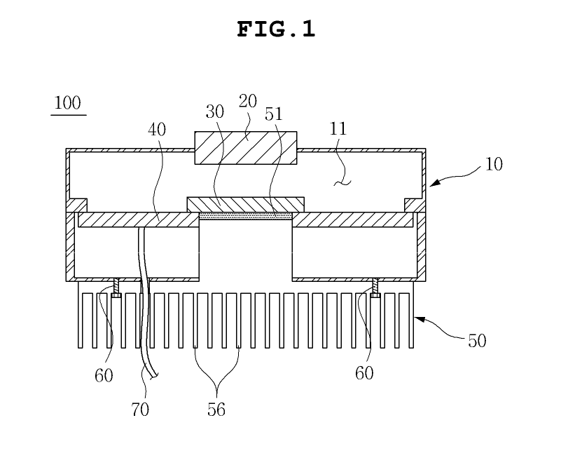

FIG. 1 is a cross-sectional view showing a camera module according to a preferred embodiment of the present invention.

Referring to FIG. 1, a camera module 100 according to a preferred embodiment of the present invention is configured to include a housing 10, a printed circuit board 40 disposed in the housing 10, an image sensor 20 bonded to the printed circuit board 40, and a heat dissipating part 50 discharging heat generated from the image sensor 20 and the printed circuit board 40 to the outside.

Referring to FIG. 1, the housing 10 is configured in a box form having an accommodating part 11 formed therein so as to accommodate the image sensor 20 and the printed circuit board 40.

Further, the housing 10 is formed with a lens hole (not shown) penetrating through the inside and outside thereof. The lens hole is mounted with an imaging lens 20. In this case, the imaging lens 20 is shown on a top portion in FIG. 1.

Further, the imaging lens 20 may be mounted in the housing 10 while being accommodated in a lens barrel (not shown). In this configuration, the lens barrel is formed in a cylindrical shape and the inside thereof may be stacked with at least one lens.

Further, the housing 10 may be made of a plastic material having a cylindrical shape or a quadrangular cylindrical shape, but the shape of the housing 10 according to the preferred embodiment of the present invention is not limited thereto.

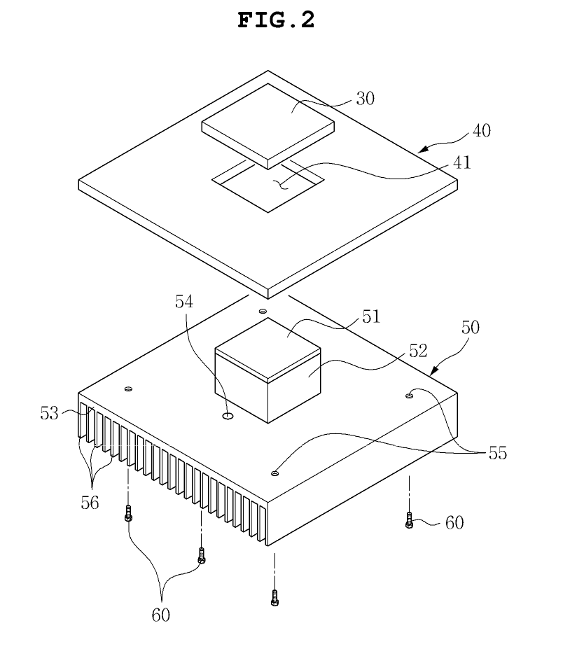

FIG. 2 is an exploded perspective view of main components of a camera module according to a preferred embodiment of the present invention.

Referring to FIGS. 1 and 2, the printed circuit board 40 (PCB) is disposed in the housing 10 and a first side thereof is provided with a heat dissipating hole 41. In this configuration, the first side may be, for example, a central portion of the printed circuit board 40.

Further, the heat dissipating hole 41 has a transverse section in a quadrangular shape and is formed so as to penetrate through the top and bottom portions of the printed circuit board 40. However, forming the transverse section shape of the heat dissipating hole 41 according to the preferred embodiment of the present invention in a quadrangular shape is only an example. Therefore, the transverse section of the heat dissipating hole may be formed in, for example, a circular shape.

Referring to FIGS. 1 and 2, the image sensor 20 is bonded to the printed circuit board 40 but is disposed on one surface of the heat dissipating hole 41 formed on the printed circuit board 40. In this configuration, the image sensor 20 may be bonded to the printed circuit board 40 so as to cover the top portion of the heat dissipating hole 41.

In addition, the image sensor 20 is disposed on the bottom portion of the imaging lens 20 to collect light incident through the imaging lens 20 and process the light as an image.

Further, the image sensor 20 is electrically connected with the printed circuit board 40 by wire bonding.

In addition, the image sensor 20 is formed with a predetermined thickness and the transverse section thereof may be formed in a quadrangular shape. However, the shape of the image sensor 20 according to the preferred embodiment of the present invention is not limited thereto. Therefore, the image sensor may be formed in, for example, a circular shape having irregular thickness.

Further, the image sensor 20 itself generates heat at the time of processing an image signal and thus, deterioration may occur at the top and bottom portions of the image sensor 20 in the inner space of the housing 10.

In this case, the heat generated from the image sensor 20 may be discharged to the outside of the image sensor 20 through the bottom surface of the image sensor 20 exposed through the heat dissipating hole 41 of the printed circuit board 40.

Referring to FIGS. 1 and 2, one side of the heat dissipating part 50 contacts the image sensor 20 and the printed circuit board 40 through the heat dissipating hole 41 and the other side thereof is disposed at the outside of the housing 10.

Further, the section shape of one side of the heat dissipating part 50 is formed to correspond to the shape of the heat dissipating hole 41. In this configuration, a section of one side of the heat dissipating part 50 may be formed in a quadrangular shape. In this case, one side of the heat dissipating part 50 may be formed of a support 52 having a quadrangular shape.

Further, the other side of the heat dissipating part 50 may be configured to include a support plate 53 and a plurality of heat dissipating plates 56 protruded to a bottom portion of the support plate 53.

Further, the support plate 53 is formed in a quadrangular plate shape and may be fixed to the bottom surface of the outside of the housing 10. In this case, the bottom portion of the housing 10 and a first portion of the support plate 53 are provided with a plurality of fixing holes 55, such that the bottom portion of the housing 10 may be fixed with the support plate 53 through a plurality of fixing members 60.

In this case, the inner sides of the fixing holes 55 formed on the bottom portion of the housing 10 and the support plate 53 are provided with threads and the fixing members 60 is formed of a screw and thus, are screwed to the fixing holes 55 formed on the support plate 53 and the housing 10.

Therefore, the bottom portion of the housing 10 may be detachably fixed with the heat dissipating part 50.

Further, the housing 10 and a second portion of the support plate 53 are provided with a connection hole 54 vertically penetrating therethrough, such that a cable 70 may penetrate through the connection hole 54. As a result, the cable 70 may be electrically connected to the bottom surface of the printed circuit board 40 by penetrating through the support plate 53 and the housing 10 from the outside of the housing 10.

Meanwhile, the heat dissipating plate 56 is formed in a quadrangular plate shape and may be vertically disposed on the bottom portion of the outside of the housing 10, but the shape of the heat dissipating plate 56 according to the preferred embodiment of the present invention is not necessarily limited to the quadrangular plate shape.

Further, the heat dissipating part 50 may be made of metal materials such as aluminum, copper, or the like, having excellent heat conductivity so as to more smoothly discharge heat generated from the image sensor 20 and the printed circuit board 40.

Meanwhile, one end of the heat dissipating part 50 further includes a buffer member 51 to absorb or prevent the impact between the image sensor 20 and the heat dissipating part 50, thereby preventing the image sensor 20 from being damaged due to the impact

Further, the buffer member 51 is disposed in the heat dissipating hole 41 formed on the printed circuit board 40 and is disposed between the image sensor 20 and the heat dissipating part 50. In this case, the top surface of the buffer member 51 contacts the bottom surface of the image sensor 20 and the side thereof contacts the inner side of the heat dissipating hole 41. Here, the buffer member 51 may be fixedly bonded to the inner side of the heat dissipating hole 41.

Further, the buffer member 51 may be made of heat conductive synthetic resin or a heat conductive material in a liquid-phase or gel form to transfer the heat generated from the image sensor 20 and the printed circuit board 40 to the heat dissipating part 50.

Further, the heat conductive synthetic resin may be made of poron.

Further, the heat conductive material in the liquid-phase or gel form may be made of thermal grease.

The preferred embodiments of the present invention can discharge the heat generated in the housing to the outside to prevent the components disposed in the housing from being damaged by heat.

In addition, the preferred embodiments of the present invention can easily discharge the heat generated from the image sensor and the printed circuit board disposed in the housing to the outside to prevent the image sensor and the electronic components disposed on the printed circuit board from being damaged by heat

Further, the preferred embodiments of the present invention can mitigate the impact of the image sensor and the heat dissipating part to prevent the breakage and damage of the image sensor.

Although the preferred embodiments of the present invention have been disclosed for illustrative purposes, they are for specifically explaining the present invention and thus the camera module according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A camera module, comprising:
a housing in which an imaging lens is mounted;
a printed circuit board disposed in the housing and having a heat dissipating hole formed at a first side thereof;
an image sensor bonded to the printed circuit board and disposed on one surface of the heat dissipating hole; and
a heat dissipating part having one side contacting the image sensor and the printed circuit board through the heat dissipating hole and the other side disposed at the outside of the housing to discharge heat generated from the image sensor and the printed circuit board to the outside of the housing.

2. The camera module as set forth in claim 1, wherein the heat dissipating part further includes a buffer member that is disposed at the heat dissipating hole of the printed circuit board and is disposed between the image sensor and the heat dissipating part to absorb impact between the image sensor and the heat dissipating part.

3. The camera module as set forth in claim 2, wherein the buffer member is formed in a pillar shape having a predetermined thickness and one surface thereof contacts the image sensor and a side thereof contacts an inner side of the heat dissipating hole of the printed circuit board.

4. The camera module as set forth in claim 3, wherein the buffer member is made of heat conductive synthetic resin.

5. The camera module as set forth in claim 4, wherein the heat conductive synthetic resin is made of poron.

6. The camera module as set forth in claim 4, wherein the buffer member is formed in a liquid-phase or gel form.

7. The camera module as set forth in claim 6, wherein the buffer member is made of thermal grease.

8. The camera module as set forth in claim 1, wherein the housing further includes a fixing member that detachably fixes the heat dissipating part.

9. The camera module as set forth in claim 8, wherein the fixing member is formed of a screw.

10. The camera module as set forth in claim 1, wherein the other side of the heat dissipating part is provided with a plurality of heat dissipating plates.

11. The camera module as set forth in claim 1, wherein the heat dissipating part is made of aluminum or copper.
